(19) United States
(12) Patent Application Publication
(10) Pub. No.: US 2010/0195888 A1
(43) Pub. Date: Aug. 5, 2010

(54) CT IMAGE RECONSTRUCTION OF A MOVING EXAMINATION OBJECT

(76) Inventor: Herbert BRUDER, Hochstadt (DE)

Correspondence Address: HARNESS, DICKEY & PIERCE, P.L.C., P.O.BOX 8910, RESTON, VA, 20195, US

(21) Appl. No.: 12/697,390

(22) Filed: Feb. 1, 2010

(30) Foreign Application Priority Data
Feb. 3, 2009 (DE) 10 2009 007 236.5

(51) Int. Cl. G06K 9/00

(52) U.S. Cl. 382/131

(57) ABSTRACT

At least one embodiment of the invention relates to a method for the scanning of a moving examination object with a CT system, in which during a rotational movement of a transmitter/receiver pair around the examination object, data is captured. Further, sectional images of the examination object are determined from the data by way of an iterative algorithm, where motion information relating to the movement of the examination object during the data acquisition is taken into account in the iterative algorithm. At least one embodiment of the invention further relates to a CT system and a computer program.

### PRIORITY STATEMENT

The present application hereby claims priority under 35 U.S.C. §119 on German patent application number DE 10 2009 007 236.5 filed Feb. 3, 2009, the entire contents of which are hereby incorporated herein by reference.

### FIELD

At least one embodiment of the invention generally relates to a method for the scanning of a moving examination object with a CT system, in which data is acquired during a rotational movement of a transmitter/receiver pair around the examination object.

### BACKGROUND

Methods for the scanning of an examination object with a CT system are generally known. Here, for example, circular scans, sequential circular scans with patient feed-through or spiral scans are employed. In the case of these scanning types, with the aid of at least one X-ray source and at least one oppositely located detector, absorption data of the examination object is recorded from different recording angles and this absorption data thus captured converted into sectional images through the examination object by way of appropriate calculation methods. Known reconstruction methods are for example FBP=filtered back projection, in which the projections are transferred into a Fourier space, where a filtering process is performed and subsequently, after the back-transformation of the data, a back projection at the sectional image level takes place.

One disadvantage of this generally known reconstruction method is that in the case of a moving examination object or an at least partially moving examination object, motion blur can arise in the image, as during the time of a scanning process for data required for an image, a shift of location of the examination object or of a part of the examination object can apply, so that the basic data resulting in an image does not all reflect a spatially identical situation of the examination object. This motion blur problem-arises in a particularly severe manner during the execution of cardio-CT examinations on a patient, in which because of the movement of the heart severe motion blur can occur in the cardiac region, or for examinations in which relatively rapid changes in the examination object are to be measured.

### SUMMARY

In at least one embodiment of the invention, a method is disclosed for the scanning of a moving examination object with a CT system. Further, a corresponding CT system and a corresponding computer program are to be presented.

In at least one embodiment of the inventive method for the scanning of a moving examination object with a CT system a transmitter/receiver pair rotates around the examination object, where data is captured during the movement. Sectional images of the examination object are determined from the data by way of an iterative algorithm, where motion information relating to the movement of the examination object during the data acquisition is taken into account in the iterative algorithm.

The circular motion around the examination object corresponds to the customary procedure in the case of CT scanning. This can take place either without patient feed-through or as a spiral-CT with such feed-through. The data is here captured in the customary manner, in that the transmitter or radiator emits X-ray radiation, this penetrates the examination object, and radiation attenuated by the examination object is detected by the receiver. The captured data thus corresponds to projections through the examination object.

A reconstruction method is employed in at least one embodiment to determine sectional images from the captured data, specifically an iterative algorithm. This means that not only is a sectional image calculated from the captured data by way of a one-off calculation, and output as the result, but that a multiple sectional image calculation takes place, where the quality of the sectional image improves from iteration to iteration. The motion information is used within the algorithm. This describes the movement of the examination object at the points in time of the data acquisition. In this way, the algorithm takes into account that the examination object was not static during the data acquisition. The movement of the examination object can here include a shifting of the entire examination object, and/or a movement of parts of the examination object relative to other parts, and/or a movement within the examination object.

In a development of at least one embodiment of the invention, the motion information indicates the location of the volume element for each volume element of the examination object, depending on the time. If the examination object is divided into individual volume elements, the motion information for each volume element corresponds to a path through the three-dimensional space, where each point or section of the path is assigned to a point in time, at which the respective volume element was located at the particular point or section. To this end it is particularly advantageous, if the motion information was determined from the data. In this case the captured data is on the one hand used to determine the motion information, and on the other to reconstruct sectional images of the examination object, to which end the motion information is required. A calculation algorithm which differs from the iterative algorithm can be employed to determine the motion information from the data. The motion field can be estimated from the image data gained at the various points in time.

According to one embodiment of the invention the data is assigned to its respective time of acquisition, and the motion information is assigned to the points in time of data acquisition, and in the case of the iterative algorithm a correlation exists between the data on the one hand and the motion information of the same point in time respectively on the other. This makes it possible, in the reconstruction of sectional images, to take account of the current state of motion of the examination object at the time of data recording.

In a development of at least one embodiment of the invention the motion information is taken into account in the iterative algorithm, in that a first sectional image is determined from the captured data via a back projection, first computation data calculated from the first sectional image by way of a projection, and in the case of back projection and projection, the motion information is taken into account in each case. Back projection and projection take the form of known methods of image reconstruction, where sectional images are calculated from data by way of the back projection, and conversely in the case of projection, data from sectional images.

It is advantageous if motion information is further taken into account in the iterative algorithm, in that a comparison between the data and the first computation data takes place, a second sectional image is determined from the result of this comparison by way of a back projection, where the motion information is taken into account in the back projection. Finally, further consideration of the motion information is possible in the iterative algorithm in that a conversion of the first and the second sectional image takes place, and second computation data is calculated from the result of this conversion by way of a projection, where the motion information is taken into account in the projection.

The use of a steepest descent method, which enables a rapid convergence of the iterative algorithm, is particularly advantageous in at least one embodiment.

At least one embodiment of the inventive CT system comprises a control and arithmetic unit for controlling the CT system, for analyzing captured data and for reconstruction of topographic images, where a program memory is provided for the storage of program code. A program code is provided in the program memory, which performs a method according to the above embodiment during operation of the CT system.

The inventive computer program of at least one embodiment has program code, in order to perform the method in accordance with the above embodiments, when the computer program is executed on a computer.

### BRIEF DESCRIPTION OF THE DRAWINGS

The invention is explained in greater detail below, on the basis of an example embodiment, wherein:

FIG. 1: shows a first CT system,

FIG. 2: shows a second CT system,

FIG. 3: shows an arrangement of an iterative algorithm.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

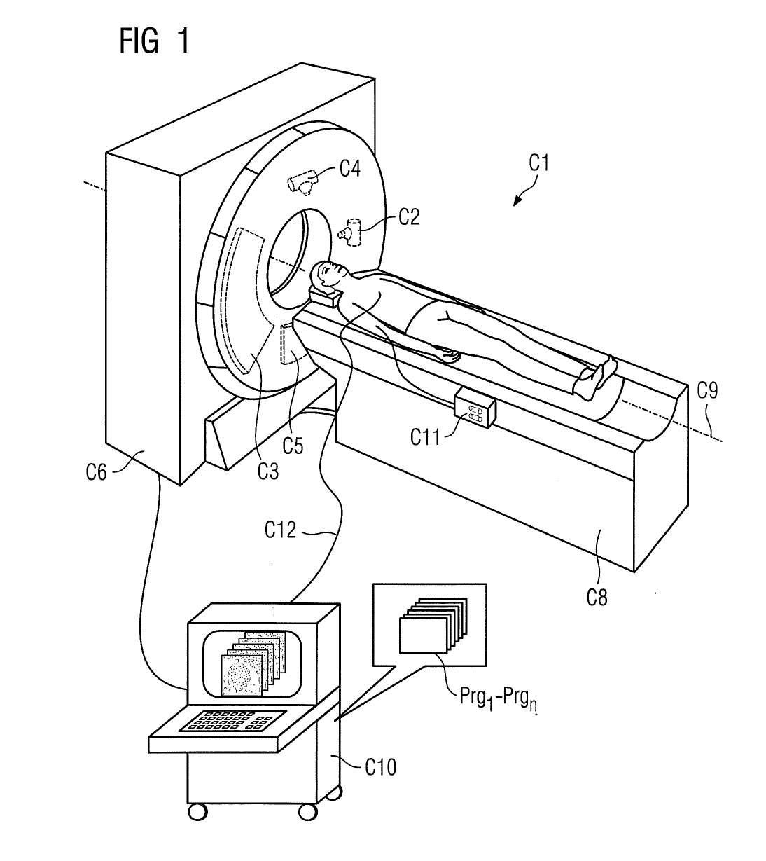

FIG. 1 shows a CT system C1 with a gantry housing C6, in which is located a closed gantry (not shown here), on which a first X-ray tube C2 with an oppositely located detector C3 are arranged. Optionally, a second X-ray tube C4 with a oppositely located detector C5 is arranged in the CT system C1 shown here, so that by way of the radiator/detector pair additionally available, a higher timing resolution can be achieved, or in the case of the use of different X-ray energy spectra in the radiator/detector systems, “Dual-Energy” examinations can also be performed. The CT system C1 further has a patient couch C8, on which a patient can be shifted during the examination along a system axis C9 within the measuring field, where the scanning itself can also take place as a pure circular scan without feed-through of the patient exclusively within the examination area of interest. Alternatively, a sequential scan can be performed, in which the patient is gradually fed through the examination field between the individual scans.

The possibility also exists, of course, of performing a spiral scan, in which during the rotational scanning with the X-ray radiation the patient can be continuously conveyed along the system axis C9 through the examination field between X-ray tube and detector. The present CT system C1 is controlled by a control and arithmetic unit C10, with a computer program code Prg₁ to Prgₙ stored in a memory. This control and arithmetic unit C10 can additionally perform the function of an ECG, where a line C12 is used to derive the ECG potentials between patient and control and arithmetic unit C10.

In addition the CT system C1 shown in FIG. 1 also has a contrast medium injector C11, via which contrast medium can be injected into the bloodstream of the patient, so that the patient's organs, in particular the ventricles of the beating heart, can be better represented. There is also hereby the possibility of performing perfusion measurements, for which the proposed method is likewise suitable.

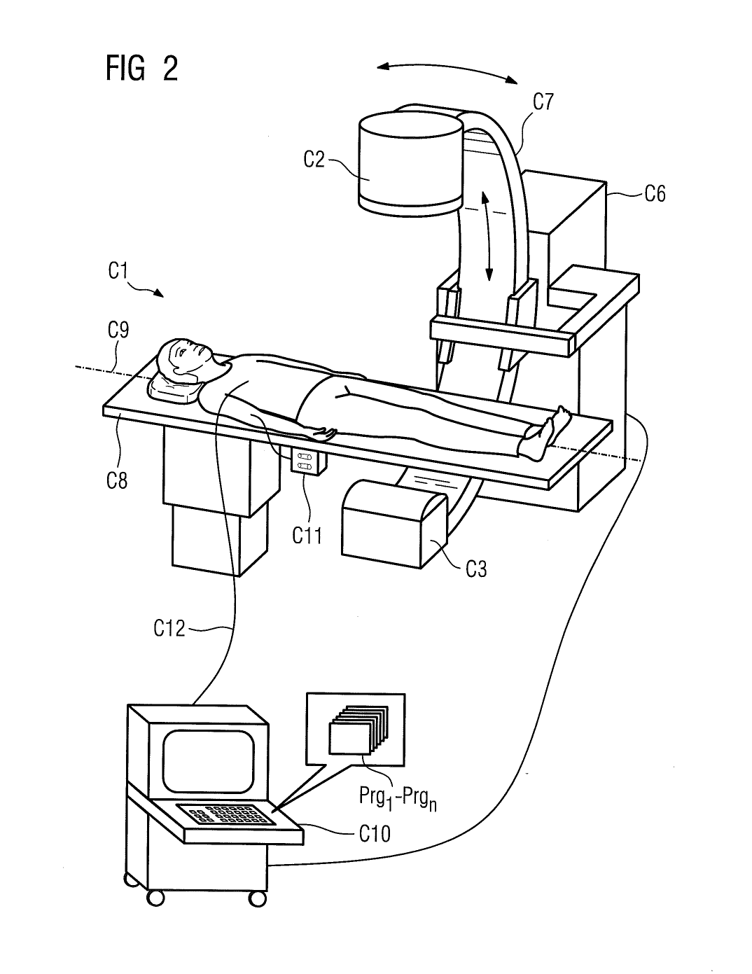

FIG. 2 shows a C-arm system C1, in which by contrast with the CT system from FIG. 1, the housing C6 carries the C-arm C7, on which on the one hand the X-ray tube C2 and on the other the oppositely located detector C3 are attached. The C-arm C7 is likewise pivoted about a system axis C9 for scanning purposes, so that scanning can take place from a multiplicity of scanning angles and corresponding projection data can be determined from a multiplicity of projection angles. Like the CT system from FIG. 1, the C-arm system C1 features a control and arithmetic unit C10 with computer program code Prg₁ to Prgₙ. In addition an ECG of the heart can also take place by way of this control and arithmetic unit C10 with the aid of an ECG-line and a contrast medium injector C11 can also be controlled via the control and arithmetic unit C10, and which can administer an injection with contrast medium in the desired form to the patient on the patient couch C8.

As in principle, the same calculation method can be used for reconstruction of sectional images in both of the tomographic X-ray systems shown, the invention can also be used for both systems.

The X-ray beam emitted by the X-ray tube C2 irradiates the patient and the X-ray radiation arriving at the detector C3 is detected at a multiplicity of projection angles during the rotation. A number of projections corresponding to the number of detector bins thus belong to each projection angle as captured data.

Making use of the recorded projections, which are delivered from the detector C3 to the control and arithmetic unit C10, the latter reconstructs sectional images of the examination object by way of suitable algorithms. In order to be able to reconstruct sensible sectional images, it is necessary to record projections at projection angles which extend over a reconstruction interval of at least 180°.

Where parts of the patient's body are to be recorded that do not move or can be immobilized, no significant problems occur during the data recording and image reconstruction. Critical on the other hand is the recording of projections and the subsequent image reconstruction of a periodically moving object. One example of such an examination object is the human heart. It is known that the human heart basically displays a periodical movement. The periodical movement here comprises an alternating sequence of relaxation or diastolic phase and a motion or beating phase. The relaxation phase generally has a duration of between 200 and 600 ms, the beating phase a duration of 300 to 400 ms.

As mentioned above, the mapping of moving examination objects in computed tomography poses a challenge. This is because as the projection data of a half circuit is required for the reconstruction of a sectional image, a certain period of time elapses during the acquisition of this data. Expressed in another way, the motion information contained in the different projections contributing to a sectional image is not consistent, as in each case a slightly changed image of the heart is seen. At a speed of rotation of the gantry or of the transmitter/receiver pair of 0.3 seconds per revolution, the maximum period of time between two projections which contribute to the same image amounts to 0.15 seconds. Accordingly, artifacts arising from the movement of the heart occur in the sectional images of the beating heart.

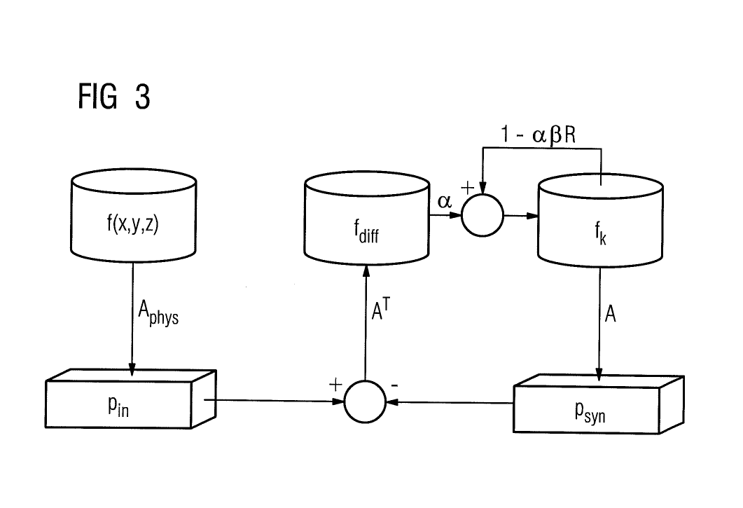

An iterative method is used for the reconstruction of the sectional images from the recorded projections, the principle of which is illustrated in FIG. 3. The input-data pᵢₙ is the recorded projections. They are obtained—from the mathematical perspective—through the application of the actual projectors A_{phys}, that is those present in reality, on the actual attenuation distribution f(x,y,z) of the examination object:

Pin=A_{phys} f(x,y,z). It is the purpose of the iterative algorithm to determine an attenuation distribution f, that is a sectional image, from the input-data pᵢₙ, which best corresponds to the actual attenuation distribution f(x,y,z) of the examination object.

To this end the operator A, a constructed projector, should map the measurement process as precisely as possible. The projector A takes the form of a model of the projector A_{phys} actually present in reality, that is of the measurement processes. Values fed into the operator A are for example a model of the tube focus, the detector aperture, detector crosstalk, etc., . . .

One example of a suitable projector A is the so-called Josephson Projector. Here, line integrals are modeled by pencil beams, that is beams with the extension of zero. Each vertex, that is each volume element, of the image volumes is linked with a basic function, e.g. trilinear, so that the contribution of the vertex to the line integral can be interpolated accordingly. The particular integral is then entered as the projection value in the respective detector bin. Operators of this kind are known per se, and described, for example, in P. M. Joseph, “An improved algorithm for reprojection rays through pixel images”, IEEE Trans. Med. Imag. 1:193-196, 1982, the entire contents of which are hereby incorporated herein by reference.

Further projectors are described for example in K. Muellerm R. Yagel, J. J. Wheller: “Fast implementations of algebraic methods for three-dimensional reconstruction of cone-beam data”, IEEE Trans. Med. Imag. 18 (6): 538-548, 1999, the entire contents of which are hereby incorporated herein by reference.

By way of the operator A^{T} adjoint to A, the sectional image, that is the calculated attenuation distribution: f=A^{T} is obtained from the projections. The back projector A^{T} represents an inexact reconstruction method. The 3-dimensional radon transformation required for exact solution is thus not fully executed. Accordingly, the actual attenuation distribution f(x,y,z) is only approximately determined through the use of the back projector A^{T} on the input-data pᵢₙ. For this reason an iterative approach is adopted, in order to get as close as possible to the actual attenuation distribution f(x,y,z) within a number of iteration cycles.

By way of an initial reconstruction, that is a first application of the back projector A^{T} on the input-data pᵢₙ, a first attenuation distribution f₀ is calculated; this is the first estimation image. This is not represented in FIG. 3. f₀ corresponds to the value fₖ of FIG. 3 in the zeroth iteration cycle. Synthetic projections are hereafter calculated with the projector A: P_{syn}=A f₀. Here, synthetic means that measured data is not involved here, but a calculated value.

The difference between den input-data pᵢₙ and the synthetic projections P_{syn} is subsequently determined. This remainder pᵢₙ-P_{syn} is in turn employed to calculate a new attenuation distribution using the back projector A^{T}, namely the difference attenuation distribution f_{diff}:

f_{diff}=A^{T} (pᵢₙ-P_{syn}). The difference pᵢₙ-P_{syn} is thus back-projected with the operator A^{T}, in order to calculate the remainder image f_{diff}.

The addition of the difference attenuation distribution f_{diff} and the attenuation distribution f₀ calculated in the zeroth iteration cycle provides an improved attenuation distribution f₁. In FIG. 3 this corresponds to the value fₖ of the first iteration cycle. From now on the procedure described is iterated. In each iteration cycle the newly calculated data P_{syn} is thus compared with the measured data pᵢₙ. The reconstructed image fₖ is hereby better harmonized with the measured data in each iteration cycle.

In order to arrive at a convergence, further values are employed to augment the previous description of the iteration method. These take the form of the values specified in FIG. 3 in the case of the addition of f_{diff} and fₖ. These are applied within the framework of a steepest descent method. z(f) would be the cost function of the attenuation distribution:

$$z ( f ) = {‖ Af - {p}_{in} ‖}_{K}^{2} + β \cdot {\sum }_{i , j}^{N} {d}_{i , j} \cdot V ( {f}_{i} - {f}_{j} ) \qquad formula ( 1 )$$

The scalar product is here defined as follows:

∥Af−pᵢₙ∥ₖ²=(Af−pᵢₙ)^{T}·K·(Af−pᵢₙ)

K involves a matrix operation, namely a convolution operation with a conventional CT reconstruction kernel.

With the aid of the potential function V the regularization term

$$β \cdot {\sum }_{i , j}^{N} {d}_{i , j} \cdot V ( {f}_{i} - {f}_{j} )$$

links the signal fᵢ and fⱼ of adjacent image voxels with index i and j and with inverse distance d_{i,j}. By way of this regularization term, certain conditions between the values of adjacent image points can be enforced.

The use of V represents a filtering of the received attenuation distributions. V is so designed that the signal differences between adjacent image points can be selectively weighted. The pixel noise can thus be adjusted within a wide range, so that noise is suppressed. The stability of the iterative reconstruction is thereby increased.

The gradient

$$\frac{d z ( f )}{d f}$$

results in:

$$\frac{d z ( f )}{d f} = 2 \cdot {A}^{T} K ( Af - {p}_{in} ) + β \cdot {\sum }_{i = 1}^{N} {e}_{i} {\sum }_{j = 1}^{N} {d}_{i , j} \cdot V ( {f}_{i} - {f}_{j} ) \qquad formula ( 2 )$$

or expressed in simplified form:

$$\frac{d z ( f )}{d f} = 2 \cdot {A}^{T} K ( Af - {p}_{in} ) + β \cdot R \cdot f$$

Here eᵢ=(0, . . . ,0,1,0, . . . 0) with 1 at the i-th position of the image vector f indicates a unit vector.

Thus in the k-th iteration step the iterated attenuation distribution can be calculated:

$${f}_{k + 1} = {f}_{k} + α \cdot \frac{d z ( {f}_{k} )}{d f} \qquad formula ( 3 )$$

The sectional image sought is thus obtained from the formula (3).

The iterative method described thus far is known per se and is illustrated in detail for example in

J. Sunnegard: “Combining Analytical and Iterative Reconstruction in Helical Cone-Beam CT”, Thesis No 1301 Linkoping Studies and Technology, 2007, the entire contents of which are hereby incorporated herein by reference.

The movement of the heart was not taken into account in the previous investigation; the projection with the operator A and the back projection with the operator A^{T} have been regarded as time-independent operations.

In the following it is assumed that a motion field \vec{m}(\vec{r}, t) at location \vec{r} at time t is known. For each volume element of the heart, this motion field \vec{m}(\vec{r},t) specifies at which location \vec{r} the volume element is located at time t; expressed differently, motion field \vec{m}(\vec{r}, t) corresponds to the temporal change of the 3-dimensional voxel grid. Thus if the motion field \vec{m}(\vec{r},t) is present, then the entire motion sequence of the heart is known. To determine the motion field \vec{m}(\vec{r},t) the same data is applied as is also used for the image reconstruction, of which the input-data pᵢₙ thus also forms a part. It is hereby ensured that the motion field \vec{m}(\vec{r},t) relates to the same movements as also affect the image reconstruction.

A method for determining the motion field \vec{m}(\vec{r},t) is presented, for example, in

U. van Stevendaal, J. von Berg, C. Lorenz, M. Grass: “A motion-compensated scheme for helical cone-beam reconstruction in cardiac CT angiography”, Med. Phys. 35(7), July 2008, pages 3239 ff, the entire contents of which are hereby incorporated herein by reference.

The knowledge of the motion field \vec{m}(\vec{r},t) is now applied to calculating the projections and back projections within the iterative reconstruction method illustrated above. For each captured projection—and in a similar manner each calculated, that is synthetic projection—the point in time of the data acquisition is known. Accordingly, based on the motion field \vec{m}(\vec{r},t) it is known for each volume element of the heart, where it was located at the time of recording of a particular projection. Different motion states of the heart assigned to the different projections based on the time t of their acquisition. The cardiac movement can thus be taken into account in the calculation of projections and back projections.

The attenuation value fₖ(\vec{r}) at location \vec{r} is thus entered at location \vec{r}′=\vec{m}(\vec{r},t), and the projection is performed on the non-equidistant image volumes \vec{r}′. The image volume is distorted as a function of time, so that in general adjacent synthesized projections p_{syn}=Af(\vec{r}′(t)) are calculated from deformed image volumes. The difference signal pᵢₙ−p_{syn} is likewise back-projected onto the deformed image volumes with coordinates \vec{r}′(t).

It is possible to illustrate the distortion of the image volumes in dimensions in the following manner:

The object space should be imagined as a two-dimensional pixel grid, that the object itself is, as presently observed, two-dimensional. On the pixel grid a vector function m(x,y,t0, t) of the variables x, y and t is defined which specifies how, at time t, the (e.g. cartesian) pixel grid existing at time t0 is being transformed. After this transformation, generally no further cartesian image grid exists, but a more or less deformed, that is distorted grid, depending on where m(x,y,t0,t) has shifted the pixel corners.

If the motion field \vec{m}(\vec{r},t) is taken into account in the iterative reconstruction, the blurring of the resulting sectional images, which arises because of the cardiac movement, is significantly reduced. The extent of the reduction here depends on the quality of the motion field \vec{m}(\vec{r},t).

The reduction in motion blur makes particular sense for CT devices which only have a slow speed of rotation of the transmitter/receiver pair. This is because here the movement of the examination object has a more dramatic effect than in the case of rapidly rotating devices.

The invention has been previously described on the basis of an exemplary embodiment. It should be understood that numerous amendments and modifications are possible, without departing from the scope of the invention.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for the scanning of a moving examination object with a CT system, comprising:
capturing data during a rotational movement of a transmitter/receiver pair of the CT system around the examination object;
determining sectional images of the examination object from the captured data by way of an iterative algorithm, where motion information relating to the movement of the examination object is taken into account during the data capturing in the iterative algorithm.

2. The method as claimed in claim 1, wherein the motion information indicates a location of a volume element for each volume element of the examination object depending on a time.

3. The method as claimed in claim 1, wherein the motion information has been determined from the data.

4. The method as claimed in claim 1, wherein
the captured data is assigned to its respective time of acquisition,
the motion information is assigned to the time of data acquisition, and
in the case of the iterative algorithm, a correlation arises between the data and the motion information of the respective same point in time.

5. The method as claimed in claim 1, wherein
according to the iterative algorithm, a first sectional image is determined from the captured data by way of a back projection, and
first computation data is calculated from the first sectional image by way of a projection, wherein the motion information is, in each case, taken into account in the back projection and in the projection.

6. The method as claimed in claim 5, wherein, according to the iterative algorithm, a comparison between the data and the first computation data takes place, a second sectional image is determined from the comparison result by way of a back projection, and the motion information is taken into account in the back projection.

7. The method as claimed in claim 5, wherein, according to the iterative algorithm, a conversion of the first and second sectional image takes place, a second computation data is calculated from the conversion result by way of a projection, and the motion information taken is into account in the projection.

8. The method as claimed in claim 1, wherein the iterative algorithm comprises a steepest descent method.

9. CT system, comprising:
a control and arithmetic unit for control of the CT system and for the analysis of captured data and for the reconstruction of tomographic images; and
a program memory for storage of program code, wherein the program code is present in the program memory, to execute the method as claimed in claim 1 during operation of the CT system.

10. A computer program comprising program code,
in order to execute the method as claimed in claim 1, when the computer program is executed on a computer.

11. The method as claimed in claim 2, wherein
the captured data is assigned to its respective time of acquisition,
the motion information is assigned to the time of data acquisition, and
in the case of the iterative algorithm, a correlation arises between the data and the motion information of the respective same point in time.

12. The method as claimed in claim 3, wherein
the captured data is assigned to its respective time of acquisition,
the motion information is assigned to the time of data acquisition, and
in the case of the iterative algorithm, a correlation arises between the data and the motion information of the respective same point in time.

13. The method as claimed in claim 6, wherein, according to the iterative algorithm, a conversion of the first and second sectional image takes place, a second computation data is calculated from the conversion result by way of a projection, and the motion information taken is into account in the projection.

14. A computer readable medium including program segments for, when executed on a computer device, causing the computer device to implement the method of claim 1.

15. A method for the scanning of a moving examination object with a CT system, comprising:
capturing data during a rotational movement of a transmitter/receiver pair of the CT system around the examination object;
determining sectional images of the examination object from the captured data by way of an iterative algorithm, where motion information relating to the movement of the examination object is taken into account during the data capturing in the iterative algorithm.
